(19) United States
(12) Patent Application Publication
(10) Pub. No.: US 2015/0159758 A1
(43) Pub. Date: Jun. 11, 2015

(54) ENGINE COOLANT PUMP SEAL WITHOUT INTERNAL BELLOWS

(71) Applicant: GM Global Technology Operations LLC, Detroit, MI (US)

(72) Inventors: Carl Eric Fonville, Ann Arbor, MI (US); Steven E. Wallace, Flushing, MI (US)

(73) Assignee: GM Global Technology Operations LLC, Detroit, MI (US)

(21) Appl. No.: 14/099,250

(22) Filed: Dec. 6, 2013

(51) Int. Cl. F16J 15/34

(52) U.S. Cl. CPC F16J 15/348; F16J 15/344

(57) ABSTRACT

One variation may include a product comprising: an engine coolant pump seal which may comprise: a primary seal ring and a mating ring wherein the primary seal ring and the mating ring may be adjacent each other; a first O-ring which may be seated inside the primary seal ring and a second O-ring which may be seated inside the mating ring; a first and a second pad, wherein the first pad may be adjacent the primary seal and the second pad may be adjacent the mating ring; a cartridge, a key, and a spring, wherein the key may be attached to the cartridge and wherein the spring may be positioned between the cartridge and the first pad; and a unitizer which may be adjacent the second pad.

### TECHNICAL FIELD

The field to which the disclosure generally relates to includes engine coolant pump seals.

### BACKGROUND

A vehicle may include one or more engine coolant pumps.

### SUMMARY OF ILLUSTRATIVE VARIATIONS

One variation may include a product comprising: an engine coolant pump seal which may comprise: a primary seal ring and a mating ring wherein the primary seal ring and the mating ring may be adjacent each other; a first O-ring which may be seated inside the primary seal ring and a second O-ring which may be seated inside the mating ring; a first and a second pad, wherein the first pad may be adjacent the primary seal and the second pad may be adjacent the mating ring; a cartridge, a key, and a spring, wherein the key may be attached to the cartridge and wherein the spring may be positioned between the cartridge and the first pad; and a unitizer which may be adjacent the second pad.

Other illustrative variations within the scope of the invention will become apparent from the detailed description provided hereinafter. It should be understood that the detailed description and specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a section view of an engine coolant pump seal according to a number of variations.

FIG. 2 illustrates a perspective view of an engine coolant pump according to a number of variations.

FIG. 3 illustrates a perspective view of an engine coolant pump according to a number of variations.

FIG. 4 illustrates a perspective view of an engine coolant pump seal according to a number of variations.

FIG. 5 illustrates a perspective view of an engine coolant pump seal according to a number of variations.

FIG. 6 illustrates an exploded view of an engine coolant pump seal according to a number of variations.

FIG. 7 illustrates a section view of an engine coolant pump seal according to a number of variations.

### DETAILED DESCRIPTION OF ILLUSTRATIVE VARIATIONS

The following description of the variations is merely illustrative in nature and is in no way intended to limit the scope of the invention, its application, or uses.

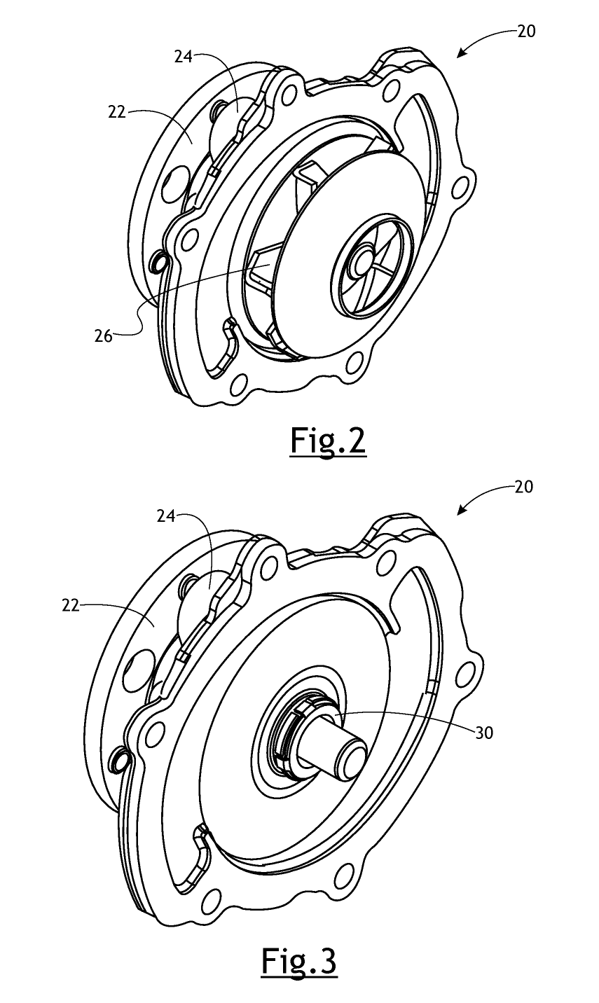

Referring to FIGS. 2-3, in any of a number of variations, an engine may include a coolant pump system 20. In any of a number of variations, a coolant pump system 20 may comprise a hub 22, a bearing assembly (not illustrated), a housing 24, an impeller 26, and a seal 30. The housing 24 may attach to any of a number of impellers 26. The bearing assembly may mechanically support the impeller 26 so that it may rotate. The hub 22 may be attached to the bearing assembly and may also be connected to a power source (not illustrated) which may cause the impeller 24 to rotate. The seal 30 in any of a number of variations may protect the bearing assembly 26 from any coolant and/or contaminates.

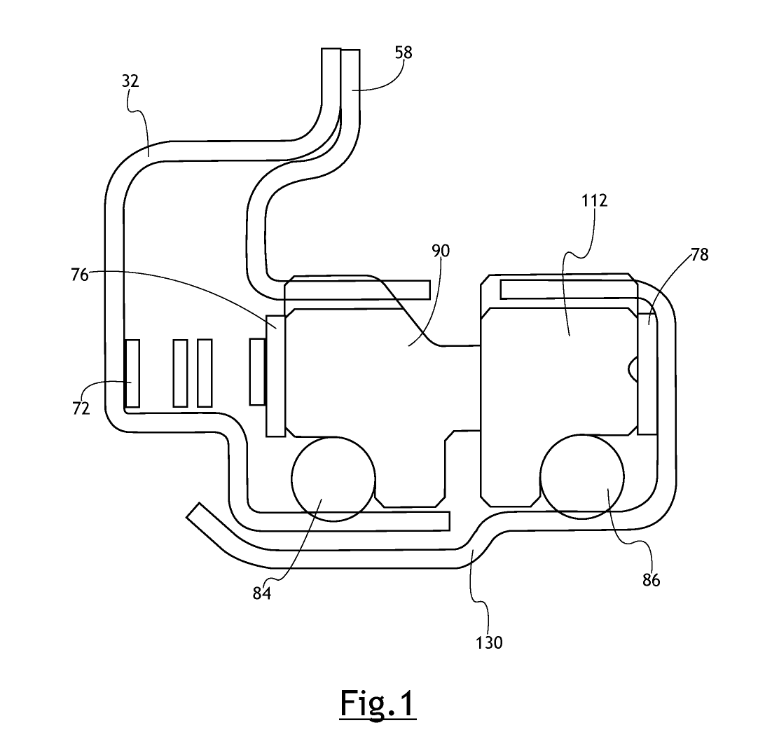

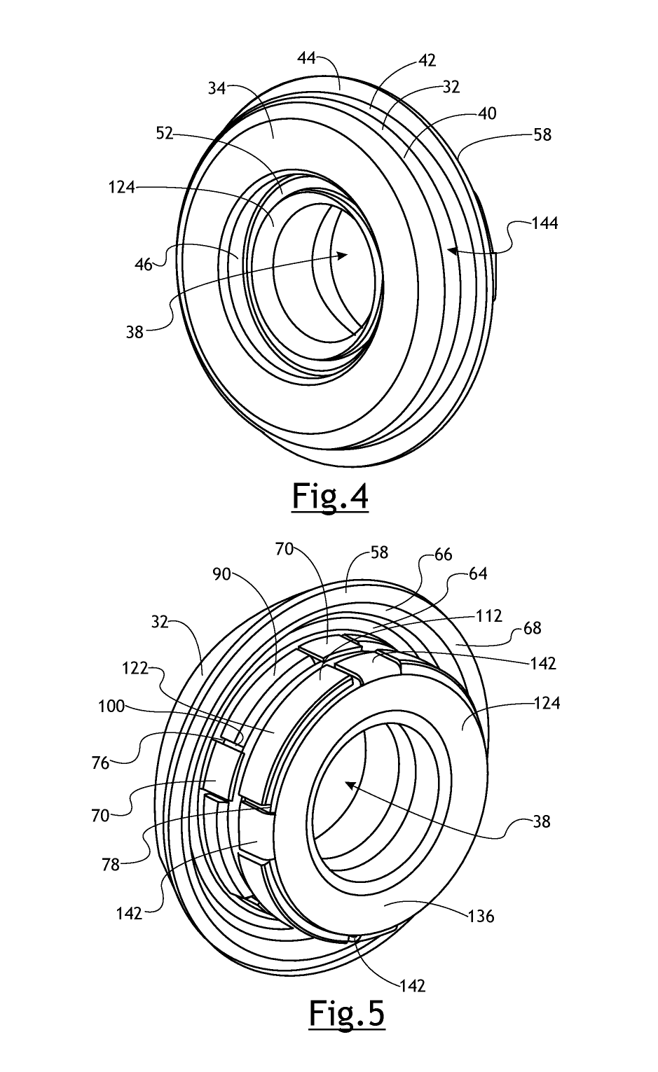

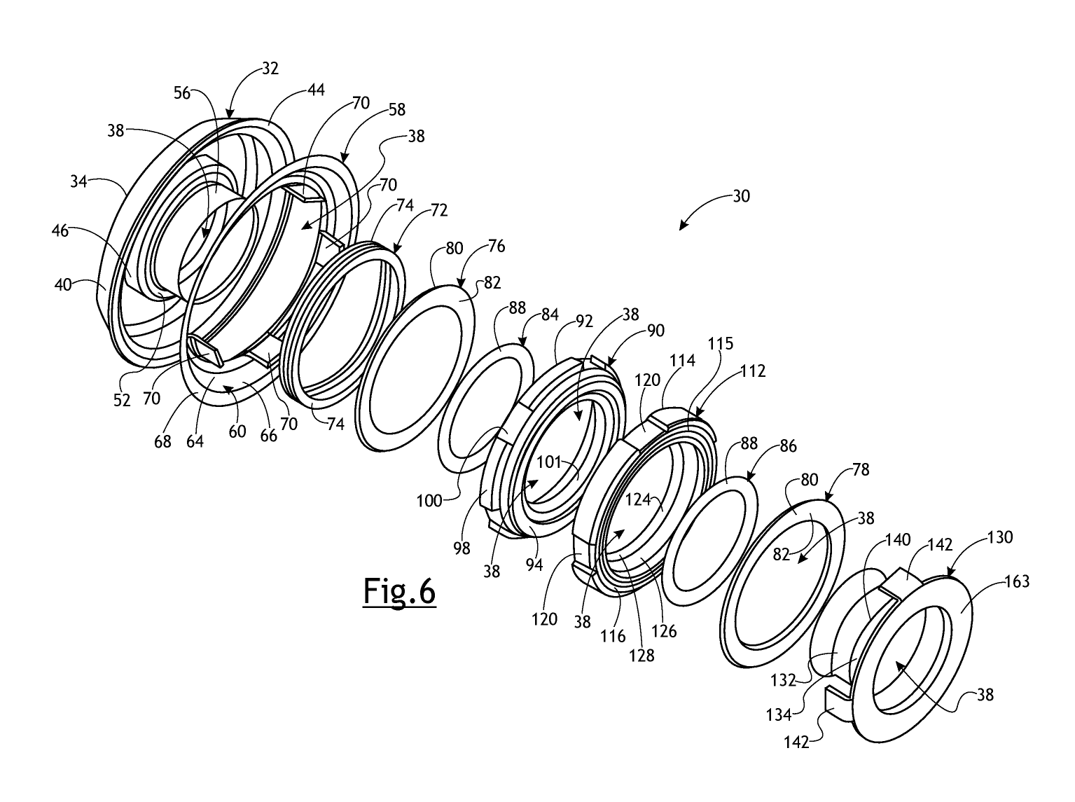

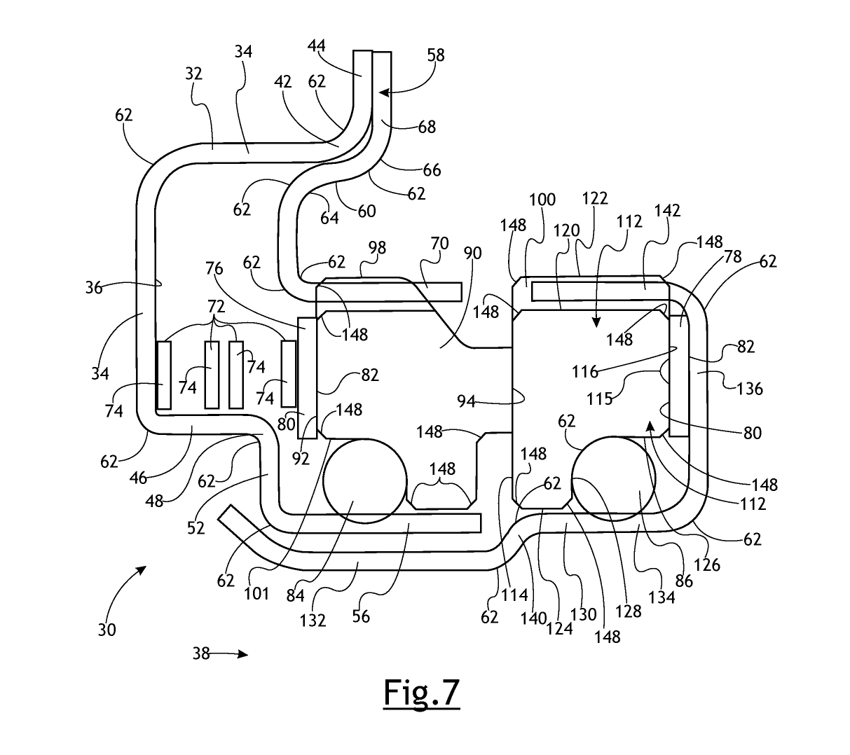

Referring to FIGS. 1, 4-7, in any of a number of variations, an engine coolant pump seal 30 may include a cartridge 32, a key 58, a spring 72, a first and second pad 76, 78, a first and second O-ring 84, 86, a primary seal ring 90, a mating ring 112, and a unitizer 130.

In any of a number of variations, a cartridge 32 may comprise a top surface 34 which may be circular in shape and which may include a cutout or hole 38 approximately central of the top surface 34. A first wall 40 may extend downward from the perimeter of the top surface 34. The first wall 40 may include a first lip 44 which may extend outward from a bottom edge 42 of the first wall 40. A second wall 46 may extend downward from the perimeter of the opening or hole 38. A second lip 52 may extend outward from a bottom edge 48 of the second wall 46. A third wall 56 may extend downward from a first edge 54 of the second lip 52. Each edge of the cartridge 32 may include a radius 62. A cartridge 32 may comprise any of a number of materials including, but not limited to, plated mild steel, stainless steel, or brass.

In any of a number of variations, a key 58 may comprise a circular wall 60 which may include a curve or radius 62. The circular wall 60 may include a first cylindrical surface 64 and a second cylindrical surface 66. In any of a number of variations, the second cylindrical surface 66 may include a diameter greater than the first cylindrical surface 64. A lip 68 may extend outward from the perimeter of the first cylindrical surface 64 and may be constructed and arranged to extend a distance so that the end of the lip 68 is approximately in line with the end of the first lip 44 on the cartridge 32. One or more tabs 70 may extend downward from the perimeter of the first cylindrical surface 64. The tabs 70 may be any of a number of shapes including, but not limited to, rectangular or square and may be constructed and arranged to mate with one or more grooves 100 on a primary seal ring 90 which may act as an anti-rotation feature as will be discussed hereafter. Each edge of the key 58 may include a radius 62. A key 58 may comprise any of a number of materials including, but not limited to, plated mild steel, stainless steel, or brass. In any of a number of variations, the key 58 may comprise sintered metal powder. In any of a number of variations, one or more elastomeric pads 76, 78 may be positioned adjacent the key 58 which may prevent chipping.

In any of a number of variations, a spring 72 may comprise a plurality of coils 74. The coils 74 may be substantially planar and circular in shape and may be constructed and arranged to fit inside the cartridge 32 adjacent the underside 36 of the top surface 34. In any of a number of variations, a spring 72 may reduce the overall package length of the engine coolant pump seal 30. A number of variations of springs 72 may be used including, but not limited to, a coiled wave spring, for example as illustrated in FIGS. 1, 6, and 7. A spring 72 may comprise any of a number of materials including, but not limited to, plated mild steel, stainless steel, or brass.

In any of a number of variations, a first and second pad 76, 78 may comprise a top face 80 and a bottom face 82. The top face 80 and the bottom face 82 may each be substantially planar and may be circular in shape and constructed and arranged to sit over the top surface 92 of the primary seal ring 90 and/or the bottom surface 116 of the mating ring 112 which will be discussed hereafter. A pad 76, 78 may comprise a rubber coated metal which may comprise any of a number of metals including, but not limited to, steel or brass which may be coated with any of a number of materials including, but not limited to, nitrile compounds, hydrogen nitrile compounds, or fluoroelastomer compounds. In any of a number of variations, the one or more pads 76, 78 may minimize axial elastomer without being flimsy. In any of a number of variations, a first and a second O-ring 84, 86 may each be torus 88 and may be constructed and arranged to fit around a second wall 101 of the primary seal ring 90 and/or a second wall 124 of a mating ring 112. An O-ring 84, 86 may comprise any of a number of materials including, but not limited to, nitrile compounds, hydrogenated nitrile compounds, or fluoroelastomer compounds.

In any of a number of variations, a primary seal ring 90 may comprise a top surface 92 and a bottom surface 94 which may each be circular in shape and may each include an opening or hole 38 approximately central of the top and bottom surfaces 92, 94. A first wall 98 may extend between the perimeter of the top surface 92 and bottom surface 94. The first wall 98 may include one or more cutouts or grooves 100 which may be constructed and arranged to accommodate one or more tabs 142 on a unitizer 130 which may act as an anti-rotation feature which will be discussed hereafter. A second wall 101 may extend from the perimeter of the opening or hole 38 between the top surface 92 and the bottom surface 94. The second wall 101 may include a lip 104 located approximately central of the second wall 101 which may extend inward. The lip 104 may comprise a top surface 106, a bottom surface 108, and a third wall 110. The top portion 102 of the second wall 101 may include a curve or radius 62 where it meets the top surface 106 of the lip 104 and may be constructed and arranged to accommodate an O-ring 84, 86 which will be discussed hereafter. The remaining edges may each include a chamfer 148. A primary seal ring 90 may comprise any of a number of materials including, but not limited to, resin bonded graphite, siliconized graphite, or bronze inserted thermoset. In any of a number of variations, the primary seal ring 90 may comprise sintered metal powder. In any of a number of variations, one or more elastomeric pads 76, 78 may be positioned adjacent the primary seal ring 90 which may prevent chipping.

In any of a number of variations, a mating ring 112 may comprise a top surface 114 and a bottom surface 116 which may each be circular in shape and which may each include an opening or hole 38 which may extend through the top surface 114 and the bottom surface 116. The top surface 114 of the mating ring 112 may include a rounded groove 115 which may extend around the top surface 114 of the mating ring 112. A first wall 122 may extend between the perimeters of the top surface 114 and the bottom surface 116. The first wall 122 may include one or more cutouts or grooves 120 which may be constructed and arranged to mate with one or more tabs 142 on a unitizer 130 which may act as an anti-rotation feature. A second wall 124 and third wall 126 may extend from the perimeter of the opening or hole 38 and may include a lip 128 which may extend therebetween. The lip 128 and the third wall 126 may include a curve or radius 62 which may be constructed and arranged to accommodate an O-ring 84, 86 as will be discussed hereafter. The remaining edges may each include a chamfer 148. A mating ring 112 may comprise any of a number of materials including, but not limited to, aluminum oxide ceramics, powered and cast metal materials, sprayed coatings, or silicon carbide. In any of a number of variations, the mating ring 112 may comprise sintered metal powder. In any of a number of variations, one or more elastomeric pads 76, 78 may be positioned adjacent the mating ring 112 which may prevent chipping.

In any of a number of variations, a unitizer 130 may comprise a first wall 132, a second wall 134, and a base surface 136 which may each extend radially from the same center point. A third wall 140 may extend at an angle between the first wall 132 and the second wall 134. The base surface 136 may comprise one or more tabs 142 which may extend upward. The tabs 142 may be any of a number of shapes including, but not limited to, square or rectangular, and may be constructed and arranged to mate with a cutout or groove 120 on a mating ring 112 as will be discussed hereafter. Each edge of the unitzer 130 may include a radius 62. A unitizer 130 may comprise any of a number of materials including, but not limited to, plated mild steel, stainless steel, or brass. In any of a number of variations, the unitizer 130 may comprise sintered metal powder. In any of a number of variations, one or more elastomeric pads 76, 78 may be positioned adjacent the unitzer 130 which may prevent chipping.

The engine coolant pump seal 30 may be assembled in any of a number of variations. The key 58 may be attached to the cartridge 32 in any of a number of variations including, but not limited to, tack welding or press fitting the key 58 into the cartridge 32. The spring 72 may then be placed adjacent the inner surface 50 of the second wall 46 on the cartridge 32 and the underside 36 of the top surface 34 of the cartridge 32. The first pad 76 may be placed over the spring 72 and may be constructed and arranged to reduce or eliminate direct contact between the coil wave spring 72 and the primary seal ring 90 and/or the cartridge 32. The first O-ring 84 may be placed adjacent the second wall 101 and the top surface 106 of the lip 104 of the primary seal ring 90. The primary seal ring 90 may then be placed into the key 58 so that the one or more tabs 70 on the key 58 are placed inside the one or more cutouts or grooves 100 in the primary seal ring 90 which may act as an anti-rotation feature and which may decrease angular stack. The cartridge 32, key 58, spring 72, first pad 76, first O-ring 84, and primary seal ring 90 may form a cartridge assembly 144. In another variation, the first pad 76 may be eliminated from the cartridge assembly 144.

In any of a number of variations, the second pad 78 may be placed adjacent the base surface 136 and one or more tabs 142 on the unitizer 130. The second pad 78 may be constructed and arranged to reduce or eliminate direct contact between the mating ring and/or the unitizer 130 which may prevent chipping. The second O-ring 86 may be placed onto the mating ring 112 adjacent the bottom surface 108 of the lip 104 and the third wall 110. The mating ring 112 may then be placed around the second wall 134 of the unitizer 130 so that the one or more tabs 142 on the unitizer 130 are placed inside the one or more cutouts or grooves 120 in the mating ring 112 which may act as an anti-rotation feature and which may decrease angular stack. The mating ring 112, second O-ring 86, second pad 78, and unitizer 130 may form a unitizer assembly 146. In another variation, the second pad 78 may be eliminated from the unitizer assembly 146.

In any of a number of variations, the cartridge assembly 144 and the unitizer assembly 146 may be compressed together and then may be mechanically locked together by swedging or swagging.

In any of a number of variations, the engine coolant pump seal 30 may then be attached to an engine coolant pump 20 which may be attached to an engine.

In any of a number of variations, the engine coolant pump seal 30 may be constructed and arranged so that an internal bellows, for example, but not limited to, a flexible membrane susceptible to temperature, pressure, and/or coolant, may be eliminated. In any of a number of variations, the engine coolant pump seal 30 may be constructed and arranged to reduce thermal growth of the engine coolant pump seal 30.

The following description of variants is only illustrative of components, elements, acts, products and methods considered to be within the scope of the invention and are not in any way intended to limit such scope by what is specifically disclosed or not expressly set forth. The components, elements, acts, products and methods as described herein may be combined and rearranged other than as expressly described herein and still are considered to be within the scope of the invention.

Variation 1 may include a product comprising: an engine coolant pump seal comprising: a primary seal ring and a mating ring wherein the primary seal ring and the mating ring are adjacent each other; a first O-ring seated inside the primary seal ring and a second O-ring seated inside the mating ring; a first and a second pad, wherein the first pad is adjacent the primary seal ring and the second pad is adjacent the mating ring; a cartridge, a key, and a spring, wherein the key is attached to the cartridge and the spring is positioned between the cartridge and the first pad; and a unitizer, wherein the unitizer is adjacent the second pad.

Variation 2 may include a product as set forth in Variation 1 wherein the key includes at least one tab and the primary seal ring includes at least one groove; wherein the at least one tab is seated in the at least one groove; and wherein the at least one tab and the at least one groove are constructed and arranged to act as an anti-rotation feature.

Variation 3 may include a product as set forth in any of Variations 1-2 wherein the unitizer includes at least one tab and the mating ring includes at least one groove; wherein the at least one tab is seated in the at least one groove; and wherein the at least one tab and the at least one groove are constructed and arranged to act as an anti-rotation feature.

Variation 4 may include a product as set forth in any of Variations 1-3 wherein the key is attached to the cartridge by tack welding.

Variation 5 may include a product as set forth in any of Variations 1-4 wherein the key is attached to the cartridge by press fitting.

Variation 6 may include a product as set forth in any of Variations 1-5 wherein the engine coolant pump seal is assembled by compressing the cartridge, the key, the spring, the first pad, the first O-ring, the primary seal ring, the mating ring, the second O-ring, the second pad, and the unitizer together and swedging the unitizer.

Variation 7 may include a product as set forth in any of Variations 1-6 wherein the cartridge comprises: a top surface; a hole approximately central of the top surface; a first wall which extends downward from a perimeter of the top surface; a first lip which extends outward from a bottom edge of the first wall; a second wall which extends downward from a perimeter of the hole; a second lip which extends outward from a bottom edge of the second wall; and a third wall which extends downward from a first edge of the second lip.

Variation 8 may include a product as set forth in any of Variations 1-7 wherein the key comprises: a circular wall which includes a first cylindrical surface and a second cylindrical surface, wherein the second cylindrical surface includes a diameter greater than the first cylindrical surface; a lip which extends outward from a perimeter of the first cylindrical surface; and at least one tab which extends downward from the perimeter of the first cylindrical surface.

Variation 9 may include a product as set forth in any of Variations 1-8 wherein the spring comprises a plurality of coils, wherein the plurality of coils are substantially planar and circular in shape and are constructed and arranged to fit inside the cartridge.

Variation 10 may include a product as set forth in any of Variations 1-9 wherein the first and the second pad each comprise: a top face and a bottom face; wherein the top face and the bottom face are circular in shape and wherein a hole extends through the top face and the bottom face approximately central of the top face and the bottom face.

Variation 11 may include a product as set forth in any of Variations 1-10 wherein the first and the second pad comprise rubber coated metal.

Variation 12 may include a product as set forth in any of Variations 1-11 wherein the first and the second O-ring are torus.

Variation 13 may include a product as set forth in any of Variations 1-12 wherein the first O-ring is constructed and arranged to fit around a second wall of the primary seal ring and the second O-ring is constructed and arranged to fit around a second wall of the mating ring.

Variation 14 may include a product as set forth in any of Variations 1-13 wherein the primary seal ring comprises: a top surface and a bottom surface which are circular in shape and wherein a hole extends through approximately central of the top surface and the bottom surface; a first wall which extends between the top surface and the bottom surface and wherein the first wall includes at least one groove which is constructed and arranged to accommodate one or more tabs on the unitizer; a second wall which extends from the perimeter of the hole between the top surface and the bottom surface; and a lip located approximately central of the second wall which extends inward, and wherein the lip comprises a top surface, a bottom surface, and a third wall.

Variation 15 may include a product as set forth in any of Variations 1-14 wherein a portion of the second wall includes a curve where it meets the top surface of the lip and wherein the curve is constructed and arranged to accommodate the first O-ring.

Variation 16 may include a product as set forth in any of Variations 1-15 wherein the mating ring comprises: a top surface and a bottom surface, wherein the top surface and the bottom surface are circular in shape and wherein a hole extends through the top surface to the bottom surface approximately central of the top surface and the bottom surface, and wherein the top surface includes a rounded circular groove which extends around the top surface; a first wall which extends between an outer perimeter of the top surface and an outer perimeter of the bottom surface and wherein the first wall includes at least one groove which is constructed and arranged to mate with at least one tab on the unitizer; a second wall which extends downward from the perimeter of the hole; a third wall which extends upward from the perimeter of the hole; and a lip which extends between the second wall and the third wall.

Variation 17 may include a product as set forth in any of Variations 1-16 wherein the lip and the third wall are constructed and arranged to accommodate the second O-ring.

Variation 18 may include a product as set forth in any of Variations 1-17 wherein the unitizer comprises: a first wall, a second wall, and a base surface which each extend radially from the same center point; a third wall which extends at an angle inward between the first wall and the second wall; a lip which extends outward at an angle from the second wall; and wherein the bottom surface comprises at least one tab which extends upward and which is constructed and arranged to mate with at least one groove on the mating ring.

Variation 19 may include a product as set forth in any of Variations 1-18 wherein the engine coolant pump seal is attached to an engine coolant pump system.

Variation 20 may include a product as set forth in any of Variations 1-19 wherein the engine coolant pump seal is constructed and arranged to protect a bearing assembly in the engine coolant pump from contaminants.

Variation 21 may include a product as set forth in any of Variations 1-20 wherein the engine coolant pump system is attached to an engine.

Variation 22 may include a product as set forth in any of Variations 1-21 wherein the engine coolant pump seal is constructed and arranged to protect a bearing assembly in an engine coolant pump system.

Variation 23 may include a product comprising: an engine coolant pump seal comprising: a primary seal ring and a mating ring wherein the primary seal ring and the mating ring are adjacent each other; a first O-ring seated inside the primary seal ring and a second O-ring seated inside the mating ring; a cartridge, a key, and a spring, wherein the key is attached to the cartridge and the spring is positioned between the cartridge and the primary seal ring; and a unitizer, wherein the unitizer is adjacent the mating ring.

The above description of select variations within the scope of the invention is merely illustrative in nature and, thus, variations or variants thereof are not to be regarded as a departure from the spirit and scope of the invention.

What is claimed is:

1. A product comprising:
an engine coolant pump seal comprising:
a primary seal ring and a mating ring wherein the primary seal ring and the mating ring are adjacent each other;
a first O-ring seated inside the primary seal ring and a second O-ring seated inside the mating ring;
a first and a second pad, wherein the first pad is adjacent the primary seal ring and the second pad is adjacent the mating ring;
a cartridge, a key, and a spring, wherein the key is attached to the cartridge and the spring is positioned between the cartridge and the first pad; and
a unitizer, wherein the unitizer is adjacent the second pad.

2. The product of claim 1 wherein the key includes at least one tab and the primary seal ring includes at least one groove;
wherein the at least one tab is seated in the at least one groove; and
wherein the at least one tab and the at least one groove are constructed and arranged to act as an anti-rotation feature.

3. The product of claim 1 wherein the unitizer includes at least one tab and the mating ring includes at least one groove;
wherein the at least one tab is seated in the at least one groove; and
wherein the at least one tab and the at least one groove are constructed and arranged to act as an anti-rotation feature.

4. The product of claim 1 wherein the engine coolant pump seal is assembled by compressing the cartridge, the key, the spring, the first pad, the first O-ring, the primary seal ring, the mating ring, the second O-ring, the second pad, and the unitizer together and swedging the unitizer.

5. The product of claim 1 wherein the cartridge comprises:
a top surface;
a hole approximately central of the top surface;
a first wall which extends downward from a perimeter of the top surface;
a first lip which extends outward from a bottom edge of the first wall;
a second wall which extends downward from a perimeter of the hole;
a second lip which extends outward from a bottom edge of the second wall; and
a third wall which extends downward from a first edge of the second lip.

6. The product of claim 1 wherein the key comprises:
a circular wall which includes a first cylindrical surface and a second cylindrical surface, wherein the second cylindrical surface includes a diameter greater than the first cylindrical surface;
a lip which extends outward from a perimeter of the first cylindrical surface; and
at least one tab which extends downward from the perimeter of the first cylindrical surface.

7. The product of claim 1 wherein the spring comprises a plurality of coils, wherein the plurality of coils are substantially planar and circular in shape and are constructed and arranged to fit inside the cartridge.

8. The product of claim 1 wherein the first and the second pad each comprise:
a top face and a bottom face;
wherein the top face and the bottom face are circular in shape and wherein a hole extends through the top face and the bottom face approximately central of the top face and the bottom face.

9. The product of claim 8 wherein the first and the second pad comprise rubber coated metal.

10. The product of claim 1 wherein the first and the second O-ring are torus.

11. The product of claim 10 wherein the first O-ring is constructed and arranged to fit around a second wall of the primary seal ring and the second O-ring is constructed and arranged to fit around a second wall of the mating ring.

12. The product of claim 1 wherein the primary seal ring comprises:
a top surface and a bottom surface which are circular in shape and wherein a hole extends through approximately central of the top surface and the bottom surface;
a first wall which extends between the top surface and the bottom surface and wherein the first wall includes at least one groove which is constructed and arranged to accommodate one or more tabs on the unitizer;
a second wall which extends from the perimeter of the hole between the top surface and the bottom surface; and
a lip located approximately central of the second wall which extends inward, and wherein the lip comprises a top surface, a bottom surface, and a third wall.

13. The product of claim 12 wherein a portion of the second wall includes a curve where it meets the top surface of the lip and wherein the curve is constructed and arranged to accommodate the first O-ring.

14. The product of claim 1 wherein the mating ring comprises:
a top surface and a bottom surface, wherein the top surface and the bottom surface are circular in shape and wherein a hole extends through the top surface to the bottom surface approximately central of the top surface and the bottom surface, and wherein the top surface includes a rounded circular groove which extends around the top surface;
a first wall which extends between an outer perimeter of the top surface and an outer perimeter of the bottom surface and wherein the first wall includes at least one groove which is constructed and arranged to mate with at least one tab on the unitizer;
a second wall which extends downward from the perimeter of the hole;
a third wall which extends upward from the perimeter of the hole; and
a lip which extends between the second wall and the third wall.

15. The product of claim 14 wherein the lip and the third wall are constructed and arranged to accommodate the second O-ring.

16. The product of claim 1 wherein the unitizer comprises:
a first wall, a second wall, and a base surface which each extend radially from the same center point;
a third wall which extends at an angle inward between the first wall and the second wall;
a lip which extends outward at an angle from the second wall; and
wherein the bottom surface comprises at least one tab which extends upward and which is constructed and arranged to mate with at least one groove on the mating ring.

17. The product of claim 1 further wherein the engine coolant pump seal is attached to an engine coolant pump system.

18. The product of claim 17 wherein the engine coolant pump seal is constructed and arranged to protect a bearing assembly in the engine coolant pump from contaminants.

19. The product of claim 1 wherein the engine coolant pump seal is constructed and arranged to protect a bearing assembly in an engine coolant pump system.

20. A product comprising:
an engine coolant pump seal comprising:
a primary seal ring and a mating ring wherein the primary seal ring and the mating ring are adjacent each other;
a first O-ring seated inside the primary seal ring and a second O-ring seated inside the mating ring;
a cartridge, a key, and a spring, wherein the key is attached to the cartridge and the spring is positioned between the cartridge and the primary seal ring; and
a unitizer, wherein the unitizer is adjacent the mating ring.
